(19) United States
(12) Patent Application Publication
(10) Pub. No.: US 2009/0080345 A1
(43) Pub. Date: Mar. 26, 2009

(54) Efficient multipoint distribution tree construction for shortest path bridging

(75) Inventor: Eric Ward Gray, Lee, NH (US)

Correspondence Address: Ansel M. Schwartz;Attorney at Law, Suite 304, 201 N. Craig Street, Pittsburgh, PA, 15213, US

(73) Assignee: Ericsson, Inc.

(21) Appl. No.: 11/903,451

(22) Filed: Sep. 21, 2007

(51) Int. Cl. H04L 12/28

(52) U.S. Cl. 370/255

(57) ABSTRACT

A telecommunications system includes a source node. The system includes a plurality of destination nodes. The system includes a network having links and end stations. The system includes a plurality of switches that create paths along links between the source nodes and the destination nodes where there is 100% efficiency along the paths with the paths traversing any link only once to the corresponding destination node from the source node, and the path being a shortest path between the source node and the destination node, where each switch has a Dijkstra computation complexity of O(N) in regard to forming the shortest paths. A method for telecommunications includes the steps of creating paths with a plurality of switches along links of a network between a source node and a plurality of destination nodes where there is 100% efficiency along the paths with the paths traversing any link only once to the corresponding destination node from the source node, and each path being a shortest path between the source node and the destination node, where each switch has a Dijkstra computation complexity of O(N) in regard to forming the shortest paths. There is the step of delivering with the switches frames from the source node to the destination nodes along the shortest paths.

### FIELD OF THE INVENTION

The present invention is related to a telecommunications system that uses shortest paths where there is 100% efficiency along the paths with the paths traversing any link only once. More specifically, the present invention is related to a telecommunications system that uses shortest paths where there is 100% efficiency along the paths with the paths traversing any link only once by computing the shortest point to point path from a source node to each destination node, and each switch forms shortest point to multipoint paths from the source node to the destination nodes without additional shortest path computations from the shortest point to point paths.

### BACKGROUND OF THE INVENTION

Currently existing technologies use spanning tree for unicast, multicast and broadcast delivery of Ethernet frames (or protocol data units—PDUs).

In development proposals have suggested (for many years) the use of shortest path construction using a (potentially modified) routing protocol.

Prior work in this area has relied on—or suggested—use of a distance vector routing protocol (DVRP), such as RIP. This approach has repeatedly been shown to have severe limitations relating to the lack of information provided by the routing protocol, and lack of support for multi-point distribution.

More recent proposals focus on use of IS-IS (intermediate system to intermediate system routing) as the core routing protocol, in part because it is easily extensible and in part because of the intrinsic creation and use of link-state routing and shortest path determination using the SPF (shortest path first) Dijkstra algorithm (so named after its inventor—Edsger Wybe Dijkstra).

One issue not adequately supported by any of these approaches is the need to support Ethernet flooding, and broadcast and multicast frame distribution.

The specific issue is that multipoint distribution requires delivery to multiple points but the path used must be loop-free or frame multiplication will occur explosively (involving exponential growth at forwarding speeds).

Because these things (flooding, broadcast and multicast) are very closely related, the approach required to support them has collectively come to be called “multipoint distribution.”

Efforts within external (e.g.—standards) organizations—such as the IEEE and IETF—have run into a choice between two limited options:
1. creation of uni-directional source based trees using per-pair shortest path computation;
2. use of a spanning tree-like bi-directional distribution tree constructed using specific reverse-path forwarding restrictions to ensure persistent loops do not occur.

Both of these options have severe limitations. The most limiting issue with the first approach is the need to perform O(n²) shortest path computations at each Ethernet switch. The most serious drawback to the second approach is the effective use of spanning tree for multipoint distribution—which:
a. goes against the intent of avoiding spanning tree entirely,
b. introduced the explicit need to use multiple algorithms for forwarding path determination, and
c. results in divergence between forwarding paths for unicast and “multipoint” traffic.

### BRIEF SUMMARY OF THE INVENTION

The present invention pertains to a telecommunications system. The system comprises a source node. The system comprises a plurality of destination nodes. The system comprises a network having links and end stations. The system comprises a plurality of switches that create paths along links between the source nodes and the destination nodes where there is 100% efficiency along the paths with the paths traversing any link only once to the corresponding destination node from the source node, and the path being a shortest path between the source node and the destination node, where each switch has a Dijkstra computation complexity of O(N) in regard to forming the shortest paths.

The present invention pertains to a method for telecommunications. The method comprises the steps of creating paths with a plurality of switches along links of a network between a source node and a plurality of destination nodes where there is 100% efficiency along the paths with the paths traversing any link only once to the corresponding destination node from the source node, and each path being a shortest path between the source node and the destination node, where each switch has a Dijkstra computation complexity of O(N) in regard to forming the shortest paths. There is the step of delivering with the switches frames from the source node to the destination nodes along the shortest paths.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of the present invention.

FIG. 2 is a block diagram of a simple network topology depicting the operation of the present invention.

FIG. 3 is a block diagram of a simple network topology depicting the operation of the present invention.

FIG. 4 is a block diagram of a simple network illustrating the difference between the shortest path technique and of the present invention and the spanning tree technique.

### DETAILED DESCRIPTION OF THE INVENTION

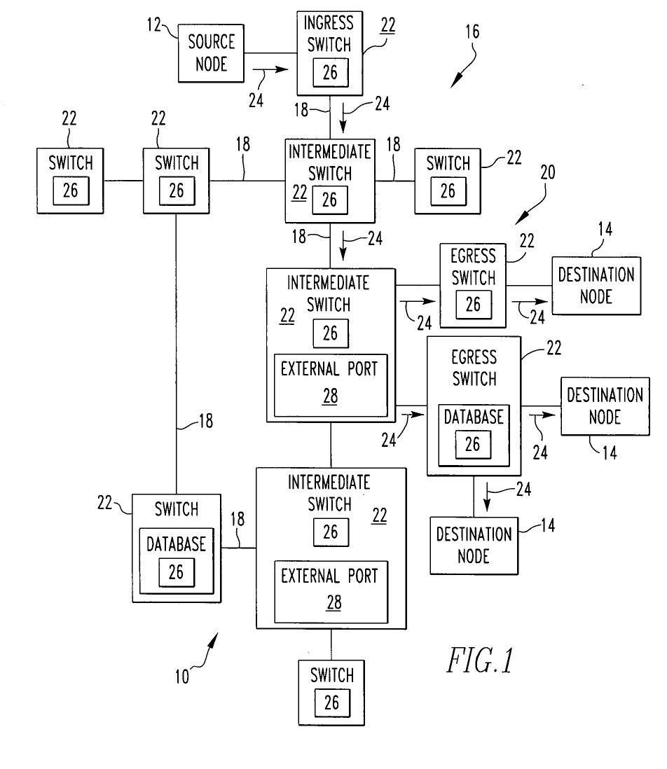

Referring now to the drawings wherein like reference numerals refer to similar or identical parts throughout the several views, and more specifically to FIG. 1 thereof, there is shown a telecommunications system 10. The system 10 comprises a source node 12. The system 10 comprises a plurality of destination nodes 14. The system 10 comprises a network 16 having links 18 and end stations 20. The system 10 comprises a plurality of switches 22 that create paths 24 along links 18 between the source nodes 12 and the destination nodes 14 where there is 100% efficiency along the paths 24 with the paths 24 traversing any link 18 only once to the corresponding destination node 14 from the source node 12, and the path 24 being a shortest path 24 between the source node 12 and the destination node 14, where each switch 22 has a Dijkstra computation complexity of O(N) in regard to forming the shortest paths 24.

Preferably, the switches 22 deliver frames from the source node 12 to the destination nodes 14 along the shortest paths 24. Each switch 22 preferably computes the shortest point to point path 24 from the source node 12 to each destination node 14, and each switch 22 forms a shortest point to multipoint paths 24 from the source node 12 to the destination nodes 14 without additional shortest path 24 computations from the shortest point to point paths 24. Preferably, each switch 22 has a link-state database 26 and establishes unicast paths 24 using the link-state database 26 and shortest path 24 computations.

Each switch 22 preferably forwards a special control message to all of the switches 22 having external ports 28 using the corresponding unicast path 24, where external ports 28 are defined as ports facing a portion of the network 16 containing end stations 20. Preferably, each switch 22 establishes unicast paths 24 for each ingress-egress switch 22 pair defined from each switch 22 with one or more external ports 28 to every other switch 22 also having at least one external port 28. The messages are preferably intercepted in each intermediate switch 22 in the network 16 and used to construct a portion of the point to multipoint paths 24 that the respective intermediate switch 22 for the ingress switch 22 that originated the message.

Preferably, a multipoint distribution tree is constructed by each intermediate switch 22 for each potential ingress switch 22, with branching added as required for shortest path 24 delivery to the corresponding addressed egress switch 22. The messages are preferably only seen at any intermediate switch 22 that is on the shortest path 24 between the ingress switch 22 that originated the message and the egress switch 22 to which it is addressed. Preferably, flooding is implemented by using a preliminary determination of whether or not each frame's media access control destination address is known prior to doing a multipoint distribution tree determination by each ingress switch 22. Only a single multipoint distribution tree is preferably constructed on a per-ingress switch 22 basis at each switch 22. Preferably, no a priori knowledge of a loop-free multipoint distribution tree is required by any switch 22 to construct the shortest paths 24.

The present invention pertains to a method for telecommunications. The method comprises the steps of creating paths 24 with a plurality of switches 22 along links 18 of a network 16 between a source node 12 and a plurality of destination nodes 14 where there is 100% efficiency along the paths 24 with the paths 24 traversing any link 18 only once to the corresponding destination node 14 from the source node 12, and each path 24 being a shortest path 24 between the source node 12 and the destination node 14, where each switch 22 has a Dijkstra computation complexity of O(N) in regard to forming the shortest paths 24. There is the step of delivering with the switches frames from the source node 12 to the destination nodes 14 along the shortest paths 24.

Preferably, the creating step includes the step of creating a shortest point to point path 24 from the source node 12 to each destination node 14 by the switches 22 and each switch 22 forms shortest point to multipoint paths 24 from the source node 12 to the destination nodes 14 without additional shortest path 24 computations from the shortest point to point paths 24. The creating step preferably includes the step of establishing unicast paths 24 using a link-state database 26 of each switch 22 and shortest path 24 computations. Preferably, there is the step of forwarding a special control message to all of the switches 22 having external ports 28 using the corresponding unicast path 24, where external ports 28 are defined as ports facing a portion of the network 16 containing end stations 20.

The establishing step preferably includes the step of establishing with each switch 22 unicast paths 24 for each ingress-egress switch 22 pair defined from each switch 22 with one or more external ports 28 to every other switch 22 also having at least one external port 28. Preferably, there are steps of intercepting the messages at each intermediate switch 22 in the network 16 and using the messages to construct a portion of the point to multipoint paths 24 that the respective intermediate switch 22 for the ingress switch 22 that originated the message. There is preferably the steps of constructing a multipoint distribution tree by each intermediate switch 22 for each potential ingress switch 22, and adding branching for shortest path 24 delivery to the corresponding addressed egress switch 22.

Preferably, there is the step of seeing the messages only at any intermediate switch 22 that is on the shortest path 24 between the ingress switch 22 that originated the message and the egress switch 22 to which it is addressed. There is preferably the step of flooding by using a preliminary determination of whether or not each frame's media access control destination address is known prior to doing a multipoint distribution tree determination by each ingress switch 22. Preferably, there is the step of constructing only a single multipoint distribution tree on a per-ingress switch 22 basis at each switch 22. The creating step preferably requires no a priori knowledge of a loop-free multipoint distribution tree by any switch 22 to construct the shortest paths 24.

In the operation of the present invention, an important feature is to use the path determination already done for determination of unicast forwarding to allow direct creation of multipoint distribution trees without additional shortest path computations.

In the discussion below, “external ports” are ports facing a portion of the network containing end-stations and/or non-SPF bridges. Implementation of a current-state, state-of-the-art compatible version of shortest path bridging requires some form of Ethernet re-encapsulation by shortest path bridges of frames received on an “external port” and de-encapsulation of SPF-bridged frames prior to forwarding on an “external port.”

In its simplest form, the invention works as follows:
1) A set of Ethernet switches establishes unicast paths using a link-state database and shortest path computation.
   a) any SPF routing protocol may be used to do this.
   b) paths are established for each ingress-egress pair (i.e. from each Ethernet switch with one or more external ports to every other Ethernet switch also having at least one external port).
2) Every Ethernet switch then forwards a special control message to all other Ethernet switches (minimally the subset having external ports in each case), using the unicast path determined in the first step above.
   a) The unicast path has already been determined using the SPF routing protocol (this might be determined through the use of a timer, either for protocol stability or strictly time-based).
   b) No a priori knowledge of a loop-free multipoint distribution tree is required.
3) These messages are intercepted at each intermediate Ethernet switch and used to construct a portion of the multipoint distribution tree at that Ethernet switch, for the ingress Ethernet switch that originated the message.
   a) A multipoint distribution tree is constructed for each potential ingress Ethernet switch, with branching added as required for shortest path delivery to the specifically addressed egress Ethernet switch.
   b) Messages will only be seen at any intermediate Ethernet switch if that switch is on the shortest path between the ingress switch that originated the message and the egress switch to which it is addressed.
4) The control message is consumed by the destination Ethernet switch.
   a) A reply acknowledging the message may or may not be required depending on the specifics of reliability required for a specific implementation.
   b) If no reply is required, the egress Ethernet switch needs only to create multipoint distribution entries as required to ensure delivery to appropriate external ports.
5) Storage efficiencies may be realized using any existing forwarding database storage techniques.
   a) This allows for re-using forwarding entries for multicast, VLAN restricted broadcast and flooding, in many cases.
6) Multipoint forwarding occurs based on the multipoint distribution forwarding entries determined in the above steps.
   a) Pruning of the distribution tree may be done as it is most commonly done in most current implementations by using some form of further discrimination filter on a per-frame basis to—for example—prevent forwarding an Ethernet frame onto an inappropriate VLAN port.
   b) Flooding may be correctly implemented by using a preliminary determination of whether or not each Ethernet frame's MAC (media access control) DA (destination address) is known (i.e.—there exists a forwarding entry in the database for that unicast MAC DA, in the applicable VLAN context), prior to doing a multipoint distribution tree determination.
   c) Effectively only a single multipoint distribution tree is constructed on a per-ingress Ethernet switch basis at each Ethernet switch.

Step 3b is critical to the invention. Because unicast delivery will follow the unicast shortest path, three things can be easily shown to be true of this invention because of step 3b:
1) Divergence between unicast forwarding and multipoint distribution paths is both easily and naturally avoided.
2) Creation of persistent loops in any multipoint distribution tree is not possible
3) Only the shortest path from any bridge to all other bridges is ever required to be computed (in other words, the Dijkstra computation complexity is O(N) at each Ethernet switch).

In addition to the above description of behavior, the details of the invention fall into 4 areas:
1. Control message content, construction and origination requirements at an ingress Ethernet SPF switch.
2. Message processing and forwarding requirements at intermediate Ethernet switches.
3. Message processing requirements at an egress Ethernet SPF switch.
4. Use of the resulting forwarding entries by each Ethernet SPF switch in forwarding Ethernet frames for multipoint distribution.

An ingress Ethernet SPF switch is one having at least one external port (as defined previously). Once the link state database is fully determined, each ingress Ethernet SPF switch must originate at least one message directed to each egress Ethernet SPF switch. In a minimalist implementation, this may be at least one message to all other Ethernet SPF switches in the switch domain, however the link state database MAY contain information about egress status for each Ethernet SPF switch in it, depending on the information content of the link state advertisement mechanisms that apply in an implementation.

Because of the need to remove entries that become invalid as a result of a change in the link state database, a minimalist implementation will very probably use the refresh mechanisms, aging and timers associated with the links state routing protocol itself. Hence it is likely that these messages will need to be constructed, and forwarded, periodically—as opposed to just one time.

The message must minimally identify:
1. That it is a specific control message type, meant to be processed by intermediate Ethernet SPF switches, using the processes of the invention.
2. That it was originated by a specific ingress Ethernet SPF switch, identified by either its MAC address (used as MAC source address, for example)—or may alternatively be some other form of identifier used (for instance) to identify the device in the SPF routing protocol.
3. That it is destined to a specific (egress) Ethernet SPF switch, similarly identified (i.e.—by MAC, as a DA, or another form of identifier).

At an intermediate switch, the message is either copied to the appropriate unicast forwarding port and processed locally, or it is processed locally and then forwarded via the appropriate unicast forwarding port. This is a choice that must be made by a local implementation, based on its processing model and the requirements for forwarding integrity that apply to that model.

Message processing consists first of parsing the destination Ethernet SPF switch identification (encoded in message origination), the originating (ingress) Ethernet SPF switch identification (also encoded in origination) and the fact that this is a control message intended for setup of the multipoint distribution tree for the identified ingress Ethernet SPF switch. The ingress and egress identification information is then used to construct a multipoint distribution tree entry for the ingress/egress pair.

In an example implementation, a multipoint distribution tree may consist of a table containing zero or more entries for any given ingress Ethernet SPF switch. If no entries exist, then any frame received for multipoint forwarding by the local switch are either premature (an entry has yet to be created), or in error; in either case, such a frame will be dropped. If one or more entries exist, then each entry will be used to represent a “copy instruction”—instructing the local switch to copy the frame to a specific forwarding port.

In the example implementation, the information extracted from the above control message may be used to construct a multipoint distribution tree table entry as follows:
1. The unicast forwarding entry associated with the identified egress Ethernet SPF switch is determined.
2. The processor looks for a matching entry in the multipoint distribution tree table.
3. If no entry is found, a new entry is created from the unicast forwarding entry found in step 1 above and added to the table.
4. If an entry is found, processing is complete and the message may be forwarded according to the unicast forwarding entry determined in step 1 above—if this has not already been done.
5. If no unicast forwarding entry is determined in step 1 above, there is either an inconsistency in the link-state database as determined by the previous intermediate switch (or originating ingress switch, if received directly from that switch) which should be resolved via the SPF routing mechanisms. In this case, the control message may either be silently dropped, or a NACK may be sent to the message originator.

How LSDB inconsistency is handled will be specific to the implementation of both link-state routing and the messaging approach used. For example, if messages are periodically repeated, silently dropping the errored message is sufficient. If the process of sending these messages is triggered by some deterministic form of LSDB consistency determination, a NACK message may be required.

At the destination egress Ethernet SPF switch, message processing differs only very slightly from processing in intermediate SPF switches. Because the message destination is also the local switch, the local (egress) SPF switch will not forward the message further. In addition, the egress switch needs to create forwarding entries consistent with typical Ethernet switch flooding, and other multipoint delivery requirements. For example, if the egress Ethernet SPF switch has two external ports associated with the same VLAN as applies to the received control message, then it must create forwarding entries for both of those ports as a result of this received message.

During the forwarding process, if an Ethernet frame is received which must be forwarded via the multipoint distribution tree, the appropriate entry set is determined for the ingress Ethernet SPF switch, and the frame is copied to all interfaces identified by that entry set.

Note that part of the information that must either be carried in the frame, or (re)determined at each intermediate Ethernet SPF switch, is the fact that the frame is to be forwarded on the multipoint distribution tree. This fact is known because the key discriminator that must be used to select forwarding entries is the ingress Ethernet SPF switch. This may be determined on a frame by frame basis either from the source MAC address in the frame being forwarded, or by some other form of identifier carried in the frame.

In this system, the distribution of control messages used to setup the multipoint distribution tree are sent using unicast delivery based on the information contained in and shortest paths determined from the link state database. Because unicast delivery will follow the unicast shortest path, three things can be easily shown to be true of this invention:
1) Divergence between unicast forwarding and multipoint distribution paths is both easily and naturally avoided.
2) Creation of persistent loops in any multipoint distribution tree is not possible
3) Only the shortest path from any bridge to all other bridges is ever required to be computed (in other words, the Dijkstra computation complexity is O(N) at each Ethernet switch).

### ABBREVIATIONS

DA Destination Address
DVRP Distance Vector Routing Protocol
IEEE International Electrical and Electronic Engineers
IETF Internet Engineering Task Force
IS-IS Intermediate System to Intermediate System (routing protocol)
LAN Local Area Network
LSA Link State Advertisements
LSDB Link State Database
MAC Media Access Control
O(X) (Notation) Order X—used to describe complexity
PDU Protocol Data Unit
RIP Routing Information Protocol
SA Source Address
SPF Shortest Path First
TRILL Transparent Routing over Lots of Links
VLAN Virtual LAN

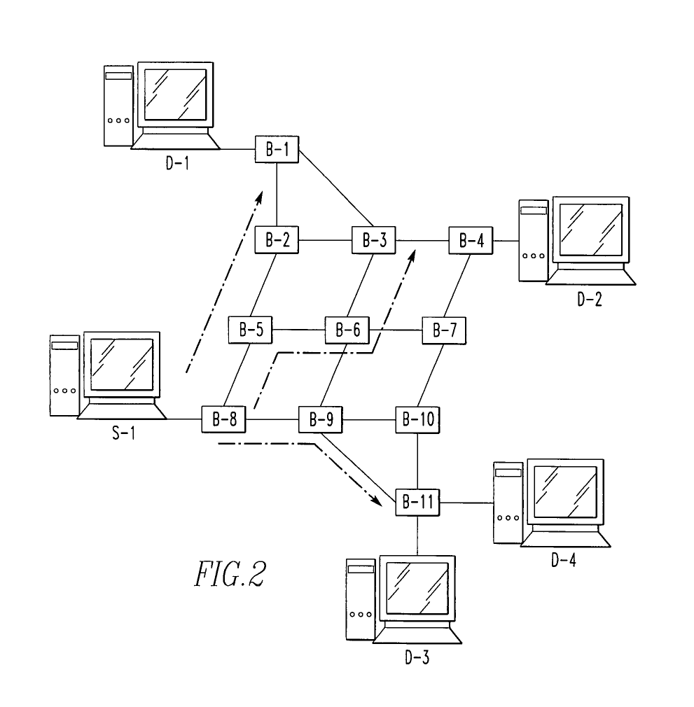

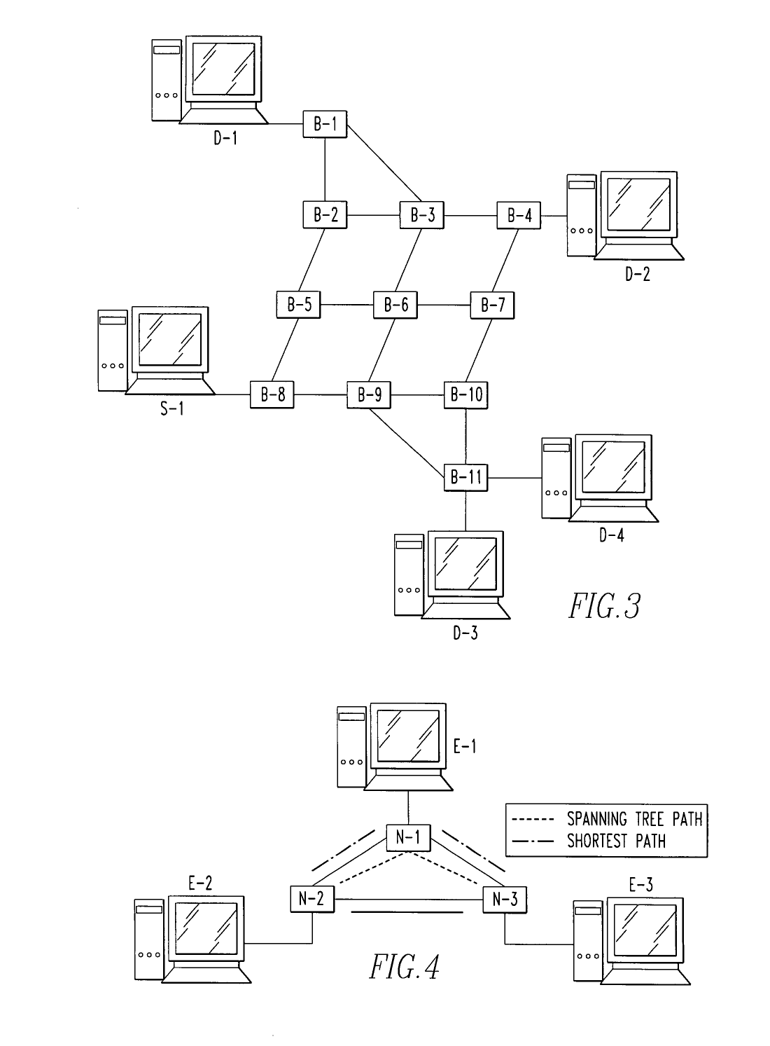

In regard to FIGS. 2 and 3:
1. Simple network topology, using the shortest path computation over a link state database to compute the shortest path at each node to all other nodes.

For example:
a) node B-1 computes a shortest path to B-2 thru B-11.
b) B-2 computes a shortest path to B-1 and B-3 thru B-11, etc.
Forwarding on a shortest path toward a single destination is simple since each node forwards exactly as if it originated the data being forwarded.
2. Delivery of multipoint traffic using shortest paths is more complicated because each node cannot forward data using the assumption that it is the source. Doing so will—in a best case result in multiple copies being delivered to each destination. Best practice is to only forward data on a shortest path from a source to each destination. Since the shortest path is unique, only one copy of the data will be delivered. However, this means that each node needs to know whether it is on the shortest path from every other node to every other node.
3. The option discussed publicly (and publicly rejected) for having each node determine this information was to do a shortest path computation, at each node, for all other nodes (where computations would include shortest paths from all of the nodes to all of the nodes). Using this approach is regarded to be unscalable for any reasonable size network.
4. Clearly not considered previously was the possibility that this information need not be re-computed. That is one of the key features of the invention: the normal shortest path computation for single destination traffic is performed and then a simple message technique is used to provide the required information to other nodes. The result is configured information for a shortest path point-to-multipoint tree rooted at all nodes.
5. Consider that it is desired to deliver traffic from source S-1 to each of the destinations D-1 thru D-4. B-8 will have computed the shortest path to all other nodes, including B-1, B-4 and B-11. For the example, we might assume:
   B-8, B-9, B-11
   B-8, B-5, B-2, B-1
   B-8, B-5, B-6, B-3, B-4
6. Having determined the shortest paths for the single destination case to be:
   B-8, B-9, B-11
   B-8, B-5, B-2, B-1
   B-8, B-5, B-6, B-3, B-4
B-8 can create its own, self-rooted, multi-point tree by sending a message to each node that is then intercepted at each intermediate node and used to “learn” that the intermediate node is on the shortest path from the specific source node to the specific destination node.
For example, B-8 sends a message to all other nodes, and that includes B-1, B-4 and B-11. The message is special in that it is intended to be intercepted and acted upon by each node and then forwarded on the continuing shortest path toward the destination.
Minimally, the message would contain source and destination information.
Hence, the message forwarded from B-8 to B-1 would be intercepted by B-5 and B-2 before it was finally delivered to B-1, and B-5 and B-2 will now know that they are on the shortest path between B-8 and B-1. Similarly, the message sent from B-8 to B-11 would be intercepted by B-9 and the message sent from B-8 to B-4 will be used by B-5, B-6 and B-3—and these then allow the intermediate nodes to “learn” that they are on the shortest path from an ingress to an egress node pair.
7. There is a trade-off involved: instead of having a shortest path computation performed N-1 more times at each node (N being the number of nodes), it is performed the same number of time as would be the case for single destination delivery but then propagated via N-1 message across intermediate nodes. The trade-off is between computational and message processing complexity.
8. Note that the multipoint tree may be setup in this approach as a single tree, rooted at a node that has as leaves all other nodes. It is not necessary to deliver data traffic to all of these nodes, however, as any of a number of well known “pruning” approaches may be in use—for example, data delivery should be restricted to applicable virtual context (such as a VLAN) and may be further restricted by interest group information (as would be the case with certain types of multicast traffic).

Traversing a path only once is not really the advantage of using the shortest path. Using spanning tree, for example, also results in having a link traversed only once (for any specific data frame). The distinction in using shortest path (that results in efficiency) is that a frame will never traverse a longer path than that which is the minimum (shortest length, or lowest cost) path. For example, in the attached network diagram (FIG. 4), the spanning tree path for traffic from E-2 to E-3 is via N-2, N-1 and N-3 while the shortest path is via N-2 and N-3 only. The spanning tree algorithm breaks a potential loop by using “blocking state” to turn off one of the redundant links while shortest path uses the uniqueness of the shortest path to ensure that traffic does not loop. Note that no link is traversed twice in either case. It is simply that—with the common spanning tree (same tree used for all traffic)—it is likely to be true that at least some of the traffic will traverse at least one more link than would be the case when using shortest paths.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A telecommunications system comprising:
a source node;
a plurality of destination nodes;
a network having links and end stations; and
a plurality of switches that create paths along links between the source nodes and the destination nodes where there is 100% efficiency along the paths with the paths traversing any link only once to the corresponding destination node from the source node, and the path being a shortest path between the source node and the destination node, where each switch has a Dijkstra computation complexity of O(N) in regard to forming the shortest paths.

2. A system as described in claim 1 wherein the switches deliver frames from the source node to the destination nodes along the shortest paths.

3. A system as described in claim 2 wherein each switch computes a shortest point to point path from the source node to each destination node, and each switch forms shortest point to multipoint paths from the source node to the destination nodes without additional shortest path computations from the shortest point to point paths.

4. A system as described in claim 3 wherein each switch has a link-state database and establishes unicast paths using the link-state database and shortest path computations.

5. A system as described in claim 4 wherein each switch forwards a special control message to all of the switches having external ports using the corresponding unicast path, where external ports are defined as ports facing a portion of the network containing end stations.

6. A system as described in claim 5 wherein each switch establishes unicast paths for each ingress-egress switch pair defined from each switch with one or more external ports to every other switch also having at least one external port.

7. A system as described in claim 6 wherein the messages are intercepted in each intermediate switch in the network and used to construct a portion of the point to multipoint paths that the respective intermediate switch for the ingress switch that originated the message.

8. A system as described in claim 7 wherein a multipoint distribution tree is constructed by each intermediate switch for each potential ingress switch, with branching added as required for shortest path delivery to the corresponding addressed egress switch.

9. A system as described in claim 8 wherein the messages are only seen at any intermediate switch that is on the shortest path between the ingress switch that originated the message and the egress switch to which it is addressed.

10. A system as described in claim 9 wherein flooding is implemented by using a preliminary determination of whether or not each frame's media access control destination address is known prior to doing a multipoint distribution tree determination by each ingress switch.

11. A system as described in claim 10 wherein only a single multipoint distribution tree is constructed on a per-ingress switch basis at each switch.

12. A system as described in claim 11 wherein no a priori knowledge of a loop-free multipoint distribution tree is required by any switch to construct the shortest paths.

13. A method for telecommunications comprising the steps of:
creating paths with a plurality of switches along links of a network between a source node and a plurality of destination nodes where there is 100% efficiency along the paths with the paths traversing any link only once to the corresponding destination node from the source node, and each path being a shortest path between the source node and the destination node, where each switch has a Dijkstra computation complexity of O(N) in regard to forming the shortest paths; and
delivering with the switches frames from the source node to the destination nodes along the shortest paths.

14. A method as described in claim 13 wherein the creating step includes the step of creating a shortest point to point path from the source node to each destination node by the switches and each switch forms shortest point to multipoint paths from the source node to the destination nodes without additional shortest path computations from the shortest point to point paths.

15. A method as described in claim 14 wherein the creating step includes the step of establishing unicast paths using a link-state database of each switch and shortest path computations.

16. A method as described in claim 15 including the step of forwarding a special control message to all of the switches having external ports using the corresponding unicast path, where external ports are defined as ports facing a portion of the network containing end stations.

17. A method as described in claim 16 wherein the establishing step includes the step of establishing with each switch unicast paths for each ingress-egress switch pair defined from each switch with one or more external ports to every other switch also having at least one external port.

18. A method as described in claim 17 including the steps of intercepting the messages at each intermediate switch in the network and using the messages to construct a portion of the point to multipoint paths that the respective intermediate switch for the ingress switch that originated the message.

19. A method as described in claim 18 including the steps of constructing a multipoint distribution tree by each intermediate switch for each potential ingress switch, and adding branching for shortest path delivery to the corresponding addressed egress switch.

20. A method as described in claim 19 including the step of seeing the messages only at any intermediate switch that is on the shortest path between the ingress switch that originated the message and the egress switch to which it is addressed.

21. A method as described in claim 20 including the step of flooding by using a preliminary determination of whether or not each frame's media access control destination address is known prior to doing a multipoint distribution tree determination by each ingress switch.

22. A method as described in claim 21 including the step of constructing only a single multipoint distribution tree on a per-ingress switch basis at each switch.

23. A method as described in claim 22 wherein the creating step requires no a priori knowledge of a loop-free multipoint distribution tree by any switch to construct the shortest paths.

24. A telecommunications system comprising:
a source node;
a plurality of destination nodes;
a network having links and end stations; and
a plurality of switches that create paths along links between the source nodes and the destination nodes where there is 100% efficiency along the paths with the paths traversing any link only once to the corresponding destination node from the source node, and the path being a shortest path between the source node and the destination node, where each switch computes a shortest point to point path from the source node to each destination node, and each switch forms shortest point to multipoint paths from the source node to the destination nodes without additional shortest path computations from the shortest point to point paths.
